(19) United States
(12) Patent Application Publication
(10) Pub. No.: US 2026/0235131 A1
(43) Pub. Date: Aug. 13, 2026

(54) MANUALLY ADJUSTED MARKING OSCILLATION ANGLE ADJUSTMENT DEVICE FOR ELECTRIC FAN

(71) Applicant: Liangjian JIANG, Guangzhou (CN)

(72) Inventor: Liangjian JIANG, Guangzhou (CN)

(21) Appl. No.: 19/472,126

(22) PCT Filed: Feb. 27, 2024
(86) PCT No.: PCT/CN2024/078656

§ 371 Date: Oct. 3, 2025

(30) Foreign Application Priority Data
Apr. 4, 2023 (CN) 202310353997.8

(51) Int. Cl. F04D 25/10; F04D 27/00

(52) U.S. Cl. CPC F04D 25/105; F04D 27/00

(57) ABSTRACT

A manually adjusted marking oscillation angle adjustment device for an electric fan, the device comprising a gear box housing (8), a housing cover (9), and a worm shaft gear (10)—large gear (11) transmission mechanism, wherein a first grading concave-convex body (19)—positioning bump clamping and positioning mechanism, a radial sliding-fit device, and a second arc limiting groove (18)—initial point limiting block (21)—end point limiting block (22) mechanism are provided between a plastic marking plate (1) and a plastic angle adjustment knob (2) located above a hollow shaft (3) and a center shaft (4); a lower end of the hollow shaft (3) is clamped and inserted into a large gear (11); a crank mechanism, which is composed of an inner eccentric gear (13), a crank (14) and a central gear (5), is provided in an inner cavity of the large gear (11); an outer wall of the inner eccentric gear (13) is provided with second grading concave-convex bodies (20), the circumferential angle of each second grading concave-convex body (20) being equal to the circumferential angle of two adjacent inner teeth of the inner eccentric gear (13); an adapter in a spring (15)—adapter device is in elastic adapted contact with an inter-body wall face of the second grading concave-convex bodies (20); and the center distance between the inner eccentric gear (13) and the crank (14) is greater than the center distance between the inner eccentric gear (13) and the central gear (5). In this way, the manually adjusted marking swig angle adjustment device for an electric fan that can avoid gear damage, increase the angle adjustment grading number, and achieve clear angle adjustment is provided.

### CROSS-REFERENCE TO RELATED APPLICATIONS

This is the U.S. National Stage of International Patent Application No. PCT/CN2024/078656 filed on Feb. 27, 2024, which claims the right of priority of China Patent Application No. 202310353997.8 filed on Apr. 4, 2023.

### FIELD OF THE INVENTION

The present disclosure relates to electric fan devices, and in particular, to a manually adjusted marking oscillation angle adjustment device for an electric fan.

### BACKGROUND OF THE INVENTION

In the related art, a oscillation angle-adjustable electric fan mainly realizes the adjustment of the oscillation angle by changing the length of the crank in the crank-rocker mechanism. In Prior Art 1 (China Patent No. 98,248,853.X), a manually adjusted stepless angle changer for an electric fan is disclosed, including a variable-length crank mechanism, which includes a limiting groove-inner eccentric gear connecting column and a central shaft gear that are engaged, provided in an eccentric gear. The user rotates the central shaft gear to drive the inner eccentric gear connecting column to make a variable-length displacement, thereby obtaining a oscillation angle for air supply at any angle. However, the reciprocating variable-length crank mechanism including the limiting groove-inner eccentric gear connecting column and the central shaft gear that are engaged being provided in the eccentric gear refers to providing an internal limiting blocking structure with limiting end blocking surfaces provided at two reciprocating ends of the limiting groove. Once the user rotates the central shaft gear in the wrong direction or applies excessive torque force, causing the central shaft gear and the inner eccentric gear connecting column to hit the limiting end blocking surface and be blocked, an overshoot torque will be generated, leading to gear damage and causing angle adjustment failure. In addition, there is no angle adjustment marking disc at the upper end of the central shaft, nor are there a stop device and a stop-indication marking. Therefore, the user must resort to guesswork to rotate the upper end of the central shaft for angle adjustment, which increases the probability of incorrect rotation direction or excessive torque force, exacerbates gear damage, and causes angle adjustment failure. This needs to be improved.

Aiming at the above shortcomings, in Prior Art 2 (Chinese Patent Application No. 202110991833.9), a manually adjusted marking oscillation angle adjustment device for an electric fan is disclosed, including a reciprocating adjustable crank structure, which includes a limiting sliding groove-sliding block rack crank and a central gear that are engaged, provided in the inner cavity of a large gear. A plastic marking disc and a plastic angle adjustment knob are concentrically arranged and provided at the upper ends of the hollow shaft and the central shaft. Each graded angular displacement angle on the plastic marking disc is equal to that of the central gear. A marking disc intermediate connection device with unique positioning connection is provided between the circular stepped stage on the hollow shaft's upper end and the marking disc. An angle adjustment knob intermediate connection device with unique positioning connection is provided between the central shaft and the angle adjustment knob. A limiting groove-limiting block mechanism is provided between the marking disc and the angle adjustment knob, thereby establishing a manually adjusted marking oscillation angle adjustment device for an electric fan that allows users to perform accurate, equally incremented angle adjustments according to the grading markings on the plastic marking disc and eliminates gear damage. However, since the eccentric displacement length generated by the linear reciprocating displacement of the sliding block rack crank driven by the central gear within the radius of the inner cavity of the large gear is constrained by the narrow inner cavity space and the requirement that the rack's teeth cannot be too fine, the effective grading number of the sliding block rack crank is relatively limited, usually difficult to exceed 5 to 6 grades. Therefore, there is a need to increase the angle adjustment grading number and the angle adjustment subdivision clarity, which needs to be further improved.

### SUMMARY OF THE INVENTION

The technical problem to be solved by the present disclosure is to provide a manually adjusted marking oscillation angle adjustment device for an electric fan, which can avoid gear damage, perform accurate, equally incremented angle adjustments according to markings on a marking disc during the manual angle adjustment process, and increase the angle adjustment grading number and the angle adjustment subdivision clarity.

To solve the foregoing technical problems, the manually adjusted marking oscillation angle adjustment device for an electric fan of the present disclosure includes a plastic marking disc, a plastic angle adjustment knob, a hollow shaft, a central shaft, and a central gear, where a circumferential angle of every two adjacent teeth of the central gear is equal to a circumferential angle of every two adjacent markings of the plastic marking disc; a plastic marking disc intermediate connection device with unique positioning connection is provided between the hollow shaft and the plastic marking disc; a plastic angle adjustment knob intermediate connection device with unique positioning connection is provided between the central shaft and the plastic angle adjustment knob, and the plastic angle adjustment knob intermediate connection device includes a two-position connecting block fixedly installed on an upper end of the central shaft through a screw; the manually adjusted marking oscillation angle adjustment device further includes a gear box housing, a housing cover, and a gear transmission mechanism; the gear transmission mechanism includes a worm shaft gear and a large gear, and a lower end of the hollow shaft is clamped and inserted into the large gear; the large gear is arranged with an inner cavity, and a variable-length crank and a spring-fastener device are provided in the inner cavity, the variable-length crank mechanism comprises the central gear, a crank and an eccentric internal gear engaged with the central gear; a limiting cover is installed below the large gear to close the inner cavity of the large gear and arranged with a first arc limiting groove, and the crank passes through the first arc limiting groove to the outside of the large gear; a second arc limiting groove and a limiting block mechanism are provided between the plastic marking disc and the plastic angle adjustment knob, and an inner wall of a second arc limiting groove is provided with a opening oriented radially toward a grading marking of the plastic marking disc; a plastic clamping and positioning mechanism and a radial sliding-fit device are provided between the plastic marking disc and the plastic angle adjustment knob, the plastic clamping and positioning mechanism comprises a first grading concave-convex body and a positioning bump that are configured for plastic clamping and positioning; an outer wall of the inner eccentric gear is provided with second grading concave-convex bodies, and a circumferential angle of every two adjacent second grading concave-convex bodies is equal to a circumferential angle of every two adjacent inner teeth of the inner eccentric gear; a fastener of the spring-fastener device is in elastic fastening contact with a wall surface between two adjacent second grading concave-convex bodies; and a center distance between the inner eccentric gear and the crank is greater than a center distance between the inner eccentric gear and the central gear.

The linear reciprocating variable-length crank mechanism, which includes a limiting sliding groove-sliding block rack crank and a central gear that are engaged as described in the technical solution of Chinese Patent Application No. 202110991833.9, is replaced with a circumferential swinging variable-length crank mechanism including the first arc limiting groove-inner eccentric gear crank and the central gear that are engaged, and the second grading concave-convex bodies are provided on the outer wall of the inner eccentric gear. The circumferential angle of each second grading concave-convex body is equal to the circumferential angle of every two adjacent inner teeth of the inner eccentric gear. Thus, the graded eccentricity displacement condition of the inner eccentric gear may be accurately fed back to the corresponding markings on the plastic angle adjustment knob and the plastic marking disc through the equivalent graded transmission of the central shaft and the hollow shaft, thereby forming an inner eccentric gear crank system with grading information. Since the circumferential swinging trajectory made by the inner eccentric gear crank within the same maximum eccentricity displacement stroke is longer than the linear displacement trajectory of the sliding block rack crank, the number of grades of formed grading markings may be greater, and the angle adjustment subdivision clarity may also be better. Further, the center distance between the inner eccentric gear and the crank is set to be greater than the center distance between the inner eccentric gear and the central gear. Therefore, the circumferential swinging trajectory of the crank may be further increased, thereby correspondingly improving the angle adjustment subdivision clarity. In addition, the groove length of the second arc limiting groove on the plastic marking disc may be correspondingly reduced based on the increased number of grades of grading markings, leaving necessary space for accommodating the limiting blocks at two ends of the plastic angle adjustment knob. Thus, the second arc limiting groove-limiting block mechanism can be provided between the plastic marking disc and the plastic angle adjustment knob, thereby overcoming the defect in the first related art where a limiting groove-limiting block mechanism cannot be provided above the inner eccentric gear crank system, and eliminating “gear damage”.

A technical solution for the second arc limiting groove-limiting block mechanism may be as follows. Limiting blocks include an initial point limiting block and an end point limiting block provided below the plastic angle adjustment knob; when an initial point limiting surface of the initial point limiting block coincides with an aligning center line of the plastic angle adjustment knob, a limiting distance from the initial point limiting block to the end point limiting block is equal to a sum of the circumferential angle of every two adjacent markings of the plastic marking disc and a distance from a circumferential angle line of the end point limiting block to a termination surface of the end point limiting block; when the initial point limiting surface of the initial point limiting block coincides with the aligning center line of the plastic angle adjustment knob, a limiting distance of the second arc limiting groove is equal to a sum of a total circumferential angle value obtained by multiplying a circumferential angle value from a center line of an initial point marking of the plastic marking disc to each grading marking by a total number of marking grades of grading markings, and the distance from the circumferential angle line of the end point limiting block to the termination surface of the end point limiting block; the initial point limiting block and the end point limiting block of the plastic angle adjustment knob are inserted into the second arc limiting groove.

Another technical solution for the second arc limiting groove-limiting block mechanism may be as follows. The limiting blocks include the initial point limiting block and the end point limiting block provided below the plastic angle adjustment knob; when there is a distance between the initial point limiting surface of the initial point limiting block and the aligning center line of the plastic angle adjustment knob, the limiting distance from the initial point limiting block to the end point limiting block is equal to a sum of the circumferential angle of every two adjacent markings of the plastic marking disc, the distance from the initial point limiting surface of the initial point limiting block to the aligning center line, and the distance from the circumferential angle line of the end point limiting block to the termination surface of the end point limiting block; when there is a distance between the initial point limiting surface of the initial point limiting block and the aligning center line of the plastic angle adjustment knob, the limiting distance of the second arc limiting groove is equal to a sum of the total circumferential angle value obtained by multiplying the circumferential angle value from the center line of the initial point marking of the plastic marking disc to each grading marking by the total number of marking grades of grading markings, the distance from the initial point limiting surface of the initial point limiting block to the aligning center line, and the distance from the circumferential angle line of the end point limiting block to the termination surface of the end point limiting block; the initial point limiting block and the end point limiting block of the plastic angle adjustment knob are inserted into the second arc limiting groove.

The fastener of the spring-fastener device may be an arc fastener having an arc convex bar at one end and a square block at the other end, and the arc convex bar of the arc fastener is in elastic fastening contact with the wall surface between two adjacent second grading concave-convex bodies.

The fastener in the spring-fastener device may alternatively be a ball, and the ball is in elastic fastening contact with the wall surface between two adjacent second grading concave-convex bodies.

By displaying the specific forms and algorithms of two technical solutions of the arc limiting groove-limiting block mechanism, and displaying the specific forms of two fasteners in the spring-fastener device, a manually adjusted marking oscillation angle adjustment device for an electric fan can be formed, which can avoid gear damage, perform accurate, equally incremented angle adjustments according to markings on the marking disc during the manual angle adjustment process, and increase the angle adjustment grading number and the angle adjustment subdivision clarity.

### BRIEF DESCRIPTION OF THE DRAWINGS

Two implementations of the present disclosure are further described below with reference to the accompanying drawings.

FIG. 1 is a rear view of a first implementation of a manually adjusted marking oscillation angle adjustment device for an electric fan of the present disclosure;

FIG. 2 is a sectional view taken along an A-A line in FIG. 1;

FIG. 3 is a top view of FIG. 1;

FIG. 4 is a top view of FIG. 1 after a limiting cover is removed;

FIG. 5 is an overall sectional view of FIG. 1;

FIG. 6 is a top exploded view of an angle adjustment component in an implementation of FIG. 1;

FIG. 7 is a bottom exploded view of an angle adjustment component in an implementation of FIG. 1;

FIG. 8 is a rear view of a plastic angle adjustment knob;

FIG. 9 is a top view of FIG. 8;

FIG. 10 is a bottom perspective view of FIG. 8;

FIG. 11 is an external view of FIG. 8;

FIG. 12 is an external view of a plastic marking disc;

FIG. 13 is a bottom view of a plastic marking disc;

FIG. 14 is a rear view of a second implementation of a manually adjusted marking oscillation angle adjustment device for an electric fan of the present disclosure;

FIG. 15 is a sectional view taken along a D-D line in FIG. 14; and

FIG. 16 is a top view of FIG. 14 after a limiting cover is removed.

### LABEL DESCRIPTION

1—plastic marking disc; 2—plastic angle adjustment knob; 3—hollow shaft; 4—central shaft; 5—central gear; 6—bidirectional connecting block; 7—screw; 8—gear box housing; 9—housing cover; 10—worm shaft gear; 11—large gear; 12—inner cavity; 13—inner eccentric gear; 14—crank; 15—spring; 16—limiting cover; 17—first arc limiting groove; 18—second arc limiting groove; 19—first grading concave-convex body; 20—second grading concave-convex body; 21—initial point limiting block; 22—end point limiting block; 23—initial point marking; 24—arc fastener; and 25—ball.

### DETAILED DESCRIPTION OF THE EMBODIMENTS

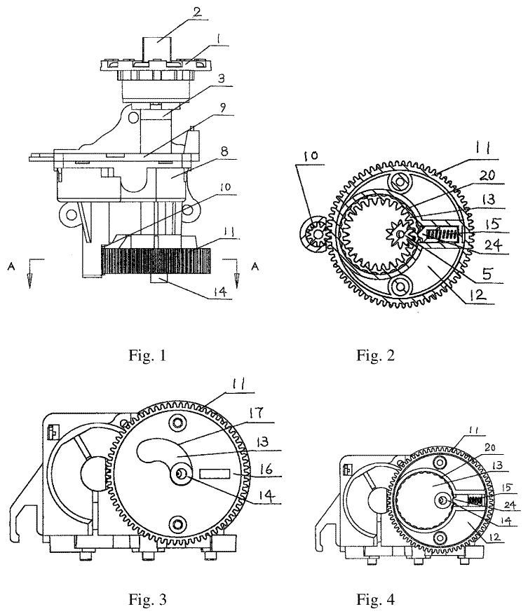

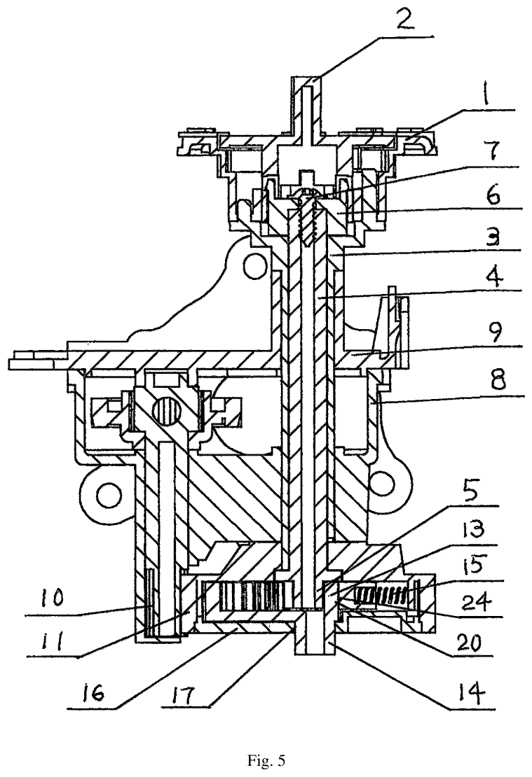

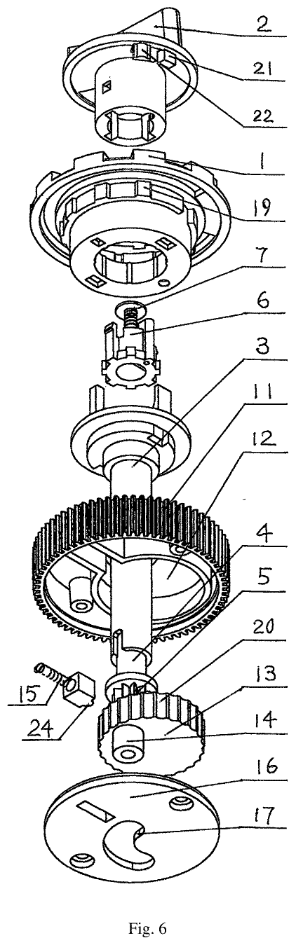

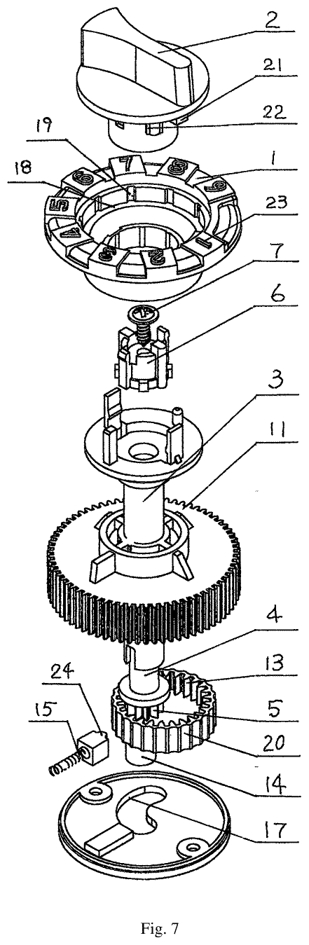

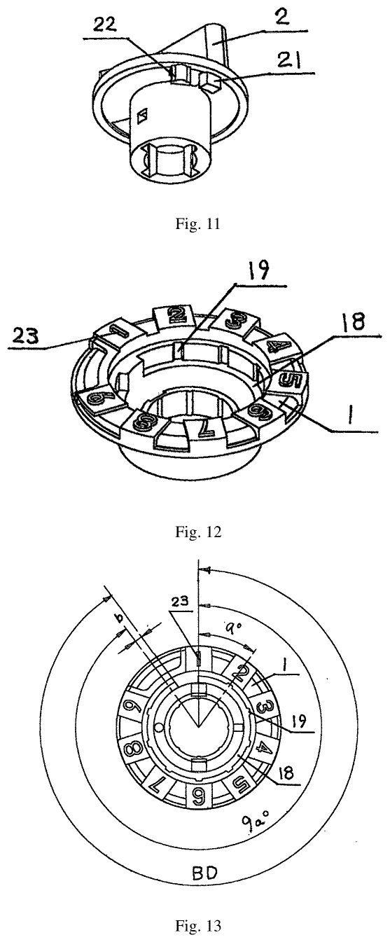

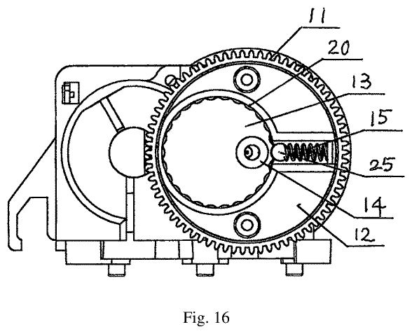

Two implementations of the present disclosure are described in detail below with reference to FIGS. 1 to 16.

The present disclosure is an improved iterative technical solution based on the existing technical solutions disclosed in inventor's Chinese Patent Application No. 202011159133.5, No. 202110283371.5, No. 202110492514.3, No. 202110991833.9, etc. The basic composition and operation of the related art are known to a person skilled in the art and will not be described in detail here. The iterative technical structure of the improved manually adjusted marking oscillation angle adjustment device for an electric fan will be described below.

Referring to FIGS. 1 to 7, a first implementation of the manually adjusted marking oscillation angle adjustment device for an electric fan of the present disclosure is as follows. A plastic marking disc 1, a plastic angle adjustment knob 2, a hollow shaft 3, a central shaft 4, and a central gear 5 are included. A circumferential angle of every two adjacent teeth of the central gear 5 is equal to a circumferential angle of every two adjacent markings of the plastic marking disc 1. A plastic marking disc intermediate connection device with unique positioning connection is provided between the hollow shaft 3 and the plastic marking disc 1. A plastic angle adjustment knob intermediate connection device with unique positioning connection is provided between the central shaft 4 and the plastic angle adjustment knob 2, and the plastic angle adjustment knob intermediate connection device includes a two-position connecting block fixedly installed on an upper end of the central shaft 4 through a screw 7. The manually adjusted marking oscillation angle adjustment device further includes a gear box housing 8, a housing cover 9, and a gear transmission mechanism. The gear transmission mechanism includes a worm shaft gear 10 and a large gear 11, and a lower end of the hollow shaft 3 is clamped and inserted into the large gear 11. The large gear 11 is arranged with an inner cavity 12, and a variable-length crank mechanism is provided in the inner cavity 12, the variable-length crank mechanism includes the central gear 5, a crank 14 and an eccentric internal gear 13 engaged with the central gear 5. A limiting cover 16 is installed below the large gear 11 to close the inner cavity 12 of the large gear 11 and arranged with a first arc limiting groove 17, and the crank 14 passes through the first arc limiting groove 17 to the outside of the large gear 11. A mechanism comprising a second arc limiting groove 18 and a limiting block is provided between the plastic marking disc 1 and the plastic angle adjustment knob 2, and an inner wall of the second arc limiting groove 18 is provided with an opening oriented radially toward a grading marking of the plastic marking disc 1. A plastic clamping and positioning mechanism and a radial sliding-fit device are provided between the plastic marking disc 1 and the plastic angle adjustment knob 2, the plastic clamping and positioning mechanism comprises a first grading concave-convex body 19 and a positioning bump that are configured for plastic clamping and positioning. An outer wall of the inner eccentric gear 13 is provided with second grading concave-convex bodies 20, and a circumferential angle of every two adjacent second grading concave-convex bodies 20 is equal to a circumferential angle of every two adjacent inner teeth of the inner eccentric gear 13. A spring 15-arc fastener 24 device having an arc convex bar at one end and a square block at the other end is provided in the inner cavity 12, and the arc convex bar of the arc fastener 24 is in elastic fastening contact with a wall surface between two adjacent second grading concave-convex bodies 20. A center distance between the inner eccentric gear 13 and the crank 14 is greater than a center distance between the inner eccentric gear 13 and the central gear 5.

The linear reciprocating variable-length crank mechanism, which includes a limiting sliding groove-sliding block rack crank and a central gear that are engaged as described in the technical solution of Chinese Patent Application No. 202110991833.9, is replaced with a circumferential swinging variable-length crank mechanism including the first arc limiting groove 17—inner eccentric gear 13 crank 14 and the central gear 5 that are engaged so that the number of grades of formed grading markings may be greater, and the angle adjustment subdivision clarity may also be better. Further, the center distance between the inner eccentric gear 13 and the crank 14 is set to be greater than the center distance between the inner eccentric gear 13 and the central gear 5. Therefore, the circumferential swinging trajectory of the crank 14 may be further increased, thereby correspondingly improving the angle adjustment subdivision clarity. In addition, the groove length of the second arc limiting groove 18 on the plastic marking disc 1 may be correspondingly reduced based on the increased number of grades of grading markings, leaving necessary space for accommodating the limiting blocks at two ends of the plastic angle adjustment knob 2. Thus, the second arc limiting groove 18—limiting block mechanism can be provided, thereby overcoming the defect in the first related art where a limiting groove-limiting block mechanism cannot be provided above the inner eccentric gear crank system, and eliminating “gear damage”.

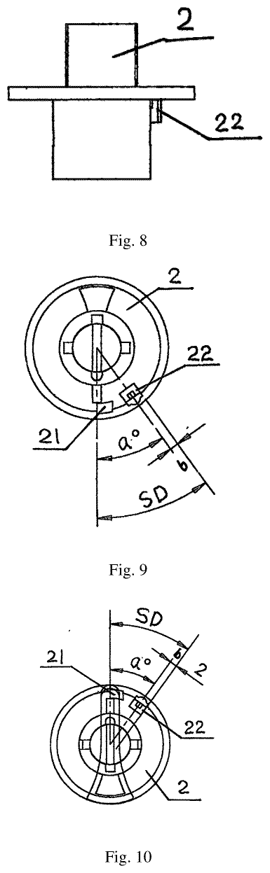

Referring to FIGS. 8 to 13, limiting blocks include an initial point limiting block 21 and an end point limiting block 22 provided below the plastic angle adjustment knob 2. When an initial point limiting surface of the initial point limiting block 21 coincides with an aligning center line of the plastic angle adjustment knob 2, a limiting distance SD from the initial point limiting block 21 to the end point limiting block 22 is equal to a sum of the circumferential angle of every two adjacent markings of the plastic marking disc 1 and a distance from a circumferential angle line of the end point limiting block 22 to a termination surface of the end point limiting block 22, i.e., SD=a°+b. When the initial point limiting surface of the initial point limiting block 21 coincides with the aligning center line of the plastic angle adjustment knob 2, a limiting distance BD of the second arc limiting groove 18 is equal to a sum of a total circumferential angle value obtained by multiplying a circumferential angle value from a center line of an initial point marking 23 of the plastic marking disc 1 to each grading marking by a total number of marking grades of grading markings, and the distance from the circumferential angle line of the end point limiting block 22 to the termination surface of the end point limiting block 22, i.e., BD=9a°+b. The initial point limiting block 21 and the end point limiting block 22 of the plastic angle adjustment knob 2 are inserted into the second arc limiting groove 18. By displaying the specific form and algorithm of the mechanism of the arc limiting groove 18—initial point limiting block 21 and end point limiting block 22, a manually adjusted marking oscillation angle adjustment device for an electric fan can be formed, which can avoid gear damage, perform accurate, equally incremented angle adjustments according to markings on the marking disc during the manual angle adjustment process, and increase the angle adjustment grading number and the angle adjustment subdivision clarity.

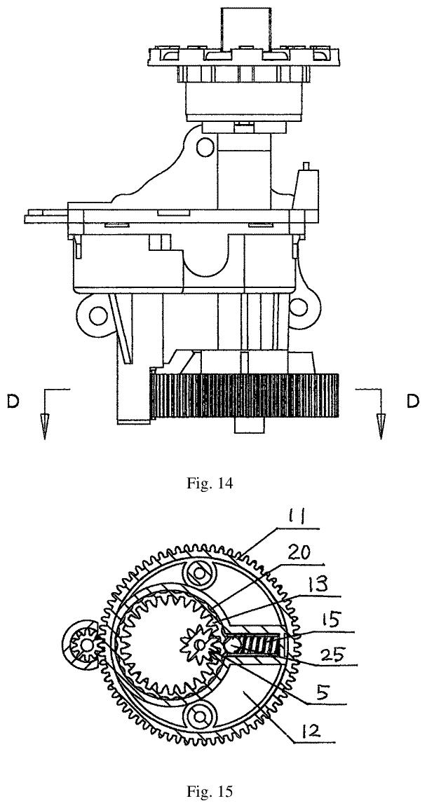

Referring to FIGS. 14 to 16, according to a second implementation of the manually adjusted marking oscillation angle adjustment device for an electric fan of the present disclosure, the overall architecture of the second implementation is essentially the same as that of the first implementation. The difference between the second implementation and the first implementation lies in that in the second implementation, the fastener in the spring 15—fastener device is a ball 25, and the ball 25 is in elastic fastening contact with the wall surface between two adjacent second grading concave-convex bodies 20. It can be understood that the elastic fastening assembly of the spring 15—arc fastener 24 device adopted in the first implementation and the spring 15—ball 25 device adopted in the second implementation can exhibit the effects of good tactile recognition clarity and accurate response at the release position and form a manually adjusted marking oscillation angle adjustment device for an electric fan, which can avoid gear damage, perform accurate, equally incremented angle adjustments according to the markings, and increase the angle adjustment grading number and the angle adjustment subdivision clarity.

Of course, in the manually adjusted marking oscillation angle adjustment device for an electric fan of the present disclosure, the specific positions of the initial point limiting surface of the initial point limiting block and the aligning center line are provided below the plastic angle adjustment knob, which are not limited to the overlapping position in the foregoing implementation and may also be deviated from the aligning center line by a certain distance. Correspondingly, the distance from the initial point limiting surface to the aligning center line may also be added to the second arc limiting groove on the plastic marking disc. The local adjustment of the initial point limiting surface and the aligning center line falls within the protection scope of the present disclosure. It is obvious that the foregoing implementations are merely part of the implementations of the present disclosure, rather than all of them. All other implementations obtained by a person skilled in the art without creative efforts based on the implementations of the present disclosure fall within the protection scope of the present disclosure.

1. A manually adjusted marking oscillation angle adjustment device for an electric fan, comprising a plastic marking disc, a plastic angle adjustment knob, a hollow shaft, a central shaft, and a central gear, wherein a circumferential angle of every two adjacent teeth of the central gear is equal to a circumferential angle of every two adjacent markings of the plastic marking disc; a plastic marking disc intermediate connection device with unique positioning connection is provided between the hollow shaft and the plastic marking disc; a plastic angle adjustment knob intermediate connection device with unique positioning connection is provided between the central shaft and the plastic angle adjustment knob, and the plastic angle adjustment knob intermediate connection device comprises a two-position connecting block fixedly installed on an upper end of the central shaft through a screw; the oscillation angle adjustment device further comprises a gear box housing, a housing cover, and a gear transmission mechanism;
the gear transmission mechanism comprises a worm shaft gear and a large gear, and a lower end of the hollow shaft is clamped and inserted into the large gear; the large gear is arranged with an inner cavity, and a variable-length crank mechanism and a spring-fastener device are provided in the inner cavity, the variable-length crank mechanism comprises the central gear, a crank and an eccentric internal gear engaged with the central gear; a limiting cover is installed below the large gear to close the inner cavity of the large gear and arranged with a first arc limiting groove, and the crank passes through the first arc limiting groove to the outside of the large gear; a second arc limiting groove and a limiting block mechanism are provided between the plastic marking disc and the plastic angle adjustment knob, and an inner wall of the second arc limiting groove is provided with an opening oriented radially toward a grading marking of the plastic marking disc; a plastic clamping and positioning mechanism and a radial sliding-fit device are provided between the plastic marking disc and the plastic angle adjustment knob, the plastic clamping and positioning mechanism comprises a first grading concave-convex body and a positioning bump that are configured for plastic clamping and positioning; an outer wall of the inner eccentric gear is provided with second grading concave-convex bodies, and a circumferential angle of every two adjacent second grading concave-convex bodies is equal to a circumferential angle of every two adjacent inner teeth of the inner eccentric gear; a fastener of the spring-fastener device is in elastic fastening contact with a wall surface between two adjacent second grading concave-convex bodies.

2. The manually adjusted marking oscillation angle adjustment device for an electric fan according to claim 1, wherein a center distance between the inner eccentric gear and the crank is greater than a center distance between the inner eccentric gear and the central gear.

3. The manually adjusted marking oscillation angle adjustment device for an electric fan according to claim 1, wherein the limiting block mechanism comprise an initial point limiting block and an end point limiting block provided below the plastic angle adjustment knob; when an initial point limiting surface of the initial point limiting block coincides with an aligning center line of the plastic angle adjustment knob, a limiting distance from the initial point limiting block to the end point limiting block is equal to a sum of the circumferential angle of every two adjacent markings of the plastic marking disc and a distance from a circumferential angle line of the end point limiting block to a termination surface of the end point limiting block; when the initial point limiting surface of the initial point limiting block coincides with the aligning center line of the plastic angle adjustment knob, a limiting distance of the second arc limiting groove is equal to a sum of a total circumferential angle value obtained by multiplying a circumferential angle value from a center line of an initial point marking of the plastic marking disc to each grading marking by a total number of marking grades of grading markings, and the distance from the circumferential angle line of the end point limiting block to the termination surface of the end point limiting block; the initial point limiting block and the end point limiting block of the plastic angle adjustment knob are inserted into the second arc limiting groove.

4. The manually adjusted marking oscillation angle adjustment device for an electric fan according to claim 3, wherein the limiting block mechanism comprise the initial point limiting block and the end point limiting block provided below the plastic angle adjustment knob; when there is a distance between the initial point limiting surface of the initial point limiting block and the aligning center line of the plastic angle adjustment knob, the limiting distance from the initial point limiting block to the end point limiting block is equal to a sum of the circumferential angle of every two adjacent markings of the plastic marking disc, the distance from the initial point limiting surface of the initial point limiting block to the aligning center line, and the distance from the circumferential angle line of the end point limiting block to the termination surface of the end point limiting block; when there is a distance between the initial point limiting surface of the initial point limiting block and the aligning center line of the plastic angle adjustment knob, the limiting distance of the second arc limiting groove is equal to a sum of the total circumferential angle value obtained by multiplying the circumferential angle value from the center line of the initial point marking of the plastic marking disc to each grading marking by the total number of marking grades of grading markings, the distance from the initial point limiting surface of the initial point limiting block to the aligning center line, and the distance from the circumferential angle line of the end point limiting block to the termination surface of the end point limiting block; the initial point limiting block and the end point limiting block of the plastic angle adjustment knob are inserted into the second arc limiting groove.

5. The manually adjusted marking oscillation angle adjustment device for an electric fan according to claim 1, wherein the fastener of the spring-fastener device is an arc fastener having an arc convex bar at one end and a square block at another end, and the arc convex bar of the arc fastener is in elastic fastening contact with the wall surface between two adjacent second grading concave-convex bodies.

6. The manually adjusted marking oscillation angle adjustment device for an electric fan according to claim 1, wherein the fastener in the spring-fastener device is a ball, and the ball is in elastic fastening contact with the wall surface between two adjacent second grading concave-convex bodies.
